(19) United States
(12) Patent Application Publication
(10) Pub. No.: US 2009/0168269 A1
(43) Pub. Date: Jul. 2, 2009

(54) CURRENT PERPENDICULAR TO PLANE SPIN VALVE WITH HIGH-POLARIZATION MATERIAL IN AP1 LAYER FOR REDUCED SPIN TORQUE

(76) Inventors: Matthew Joseph Carey, San Jose, CA (US); Jeffrey Robinson Childress, San Jose, CA (US); Stefan Maat, San Jose, CA (US); Neil Smith, San Jose, CA (US)

Correspondence Address: ZILKA-KOTAB, PC- HIT, P.O. BOX 721120, SAN JOSE, CA, 95172-1120, US

(21) Appl. No.: 11/966,017

(22) Filed: Dec. 28, 2007

(51) Int. Cl. G11B 5/33

(52) U.S. Cl. 360/324.11

(57) ABSTRACT

A current perpendicular to plane magnetoresistive sensor having improved resistance amplitude change and reduced spin torque noise. The sensor has an antiparallel coupled pinned layer structure with at least one of the layers of the pinned layer structure includes a high spin polarization material such as Co₂FeGe. The sensor can also include an antiparallel coupled free layer.

### FIELD OF THE INVENTION

The present invention relates to magnetoresistive sensors and more particularly to a current perpendicular to plane (CPP) magnetoresistive sensor with reduced spin torque noise and improved signal to noise ratio.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, hereinafter referred to as a spacer layer, sandwiched between a magnetic pinned layer structure and a free layer. First and second leads are connected to the spin valve sensor for conducting a sense current therethrough. The magnetization of the pinned layer is oriented generally perpendicular to the air bearing surface (ABS) and the magnetic moment of the free layer is oriented generally parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

When a spin valve sensor employs a single pinned layer it is referred to as a simple spin valve. When a spin valve employs an antiparallel (AP) pinned layer it is referred to as an AP pinned spin valve. An AP spin valve includes first and second magnetic layers separated by a thin non-magnetic coupling layer such as Ru. The thickness of the spacer layer is chosen so as to antiparallel couple the magnetizations of the ferromagnetic layers of the pinned layer. The ferromagnetic layer next to the spacer layer is typically referred to as the reference layer. A spin valve is also known as a top or bottom spin valve depending upon whether the pinning layer is at the top (formed after the free layer) or at the bottom (before the free layer).

The CIP spin valve sensor is located between first and second nonmagnetic electrically insulating read gap layers and the first and second read gap layers are located between ferromagnetic first and second shield layers. In a CPP spin valve, the sensor is sandwiched between first and second leads which can also function as the shields. In a merged magnetic head a single ferromagnetic layer functions as the second shield layer of the read head and as the first pole piece layer of the write head. In a piggyback head the second shield layer and the first pole piece layer are separate layers.

Magnetization of the pinned layer is usually fixed by exchange coupling one of the ferromagnetic layers (AP1) with a layer of antiferromagnetic material such as PtMn, IrMn, NiMn, or IrMnX (X═Cr). While an antiferromagnetic (AFM) material does not in and of itself have a magnetization, when exchange coupled with a magnetic material, it can strongly pin the magnetization of the ferromagnetic layer.

The ever increasing demand for increased data rate and data capacity has lead a relentless push to develop magnetoresistive sensors having improved signal amplitude and reduced track width. Sensors that show promise in achieving higher signal amplitude at high recording densities are current perpendicular to plane (CPP) sensors. Such sensors conduct sense current from top to bottom, perpendicular to the planes of the sensor layers. Examples of CPP sensors include CPP GMR sensors. A CPP GMR sensor operates based on the spin dependent scattering of electrons through the sensor, similar to a more traditional current in plane (CIP) GMR sensor except that, as mentioned above, the sense current flows perpendicular to the plane of the layers.

### SUMMARY OF THE INVENTION

The present invention provides a current perpendicular to plane magnetoresistive sensor having improved resistance amplitude change and reduced spin torque noise. The sensor has an antiparallel coupled pinned layer structure wherein the AP1 layer includes a high spin polarization material such as Co₂FeGe. This can be alone or sandwiched between thin layers of standard magnet material such as CoFe. The AP2 layer can either include a high spin polarization material or be composed of standard ferromagnetic materials.

The sensor can also include an antiparallel coupled free layer structure. This can comprise standard ferromagnetic metals such as CoFe and NiFe, or one of the layers can include a layer of Co₂FeGe.

High spin polarization materials such as Co2FeGe and CoFeGe may not couple directly to an antiferromagnet such as IrMn. Similarly, poor anti-parallel coupling may be observed if the high spin polarization material is in direct contact with the antiparallel coupling layer (APC layer) such as Ru. In both of these cases, it can be advantageous to layer the high spin polarization material with a standard material such as CoFe. For example, an AP1 layer may consist of a CoFe/Co2MnGe/CoFe trilayer. The first CoFe layer couples the structure to the IrMn antiferromagnet. The second CoFe layer provides the coupling through the APC. Similarly, the AP2 layer may consist of CoFe/Co2MnGe/CoFe. In this example, the first CoFe layer provides the coupling to the APC. The second CoFe layer can give better GMR by separating the Co2MnGe from the nonmagnetic spacer material.

Other high spin polarization materials can be used in place of Co2MnGe. These include Co2MnX and CoFeX where X is one or more of Ge, Ga, Si, Sn and Al. For the purposes here, Co2MnGe will be used as the primary example.

A sensor according to the invention advantageously exhibits higher GMR, higher amplitude resistance change deltaR/R, higher delta RA and reduced signal noise over prior art magnetoresistive sensors.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an enlarged ABS view taken from circle 3 of FIG. 2 rotated 90 degrees counterclockwise, showing a dual CPP GMR sensor according to an embodiment of the invention;

FIG. 4 is an enlarged view of a pinned layer structure according to an embodiment of the invention; and

FIG. 5 is an enlarged view of a pinned layer structure according to another embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

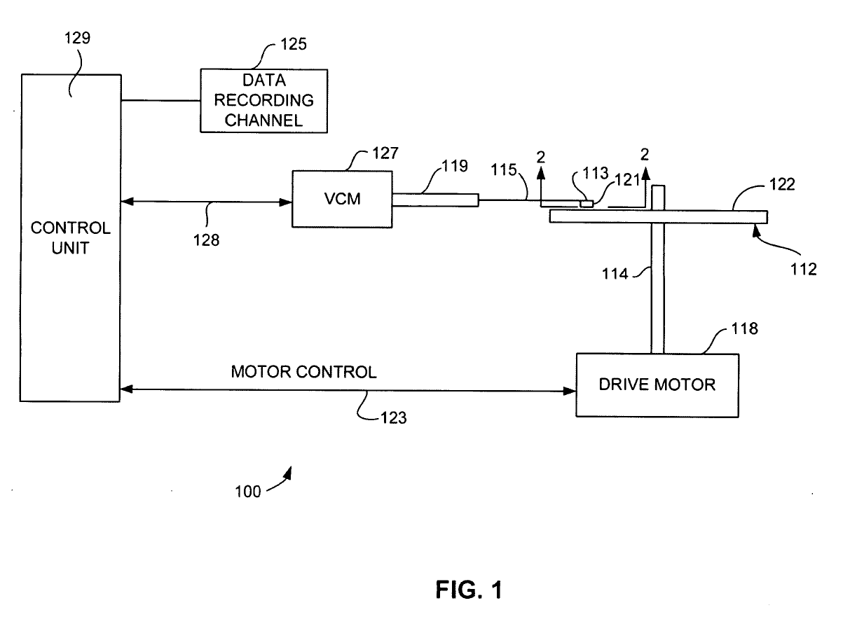

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

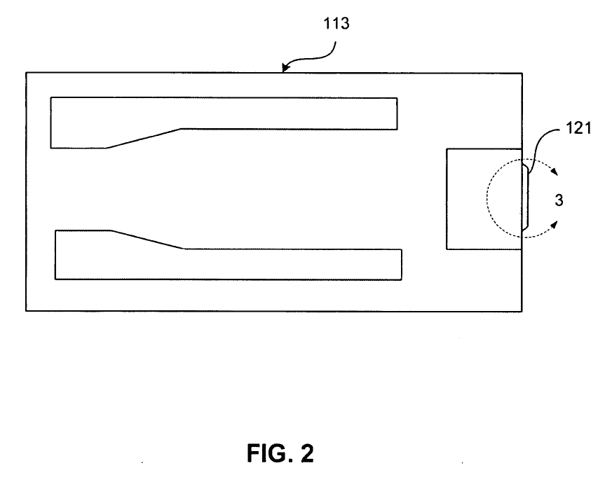

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. I are for representation purposes only. It should be apparent that disk storage systems may contain a large number of disks and actuators, and each actuator may support a number of sliders.

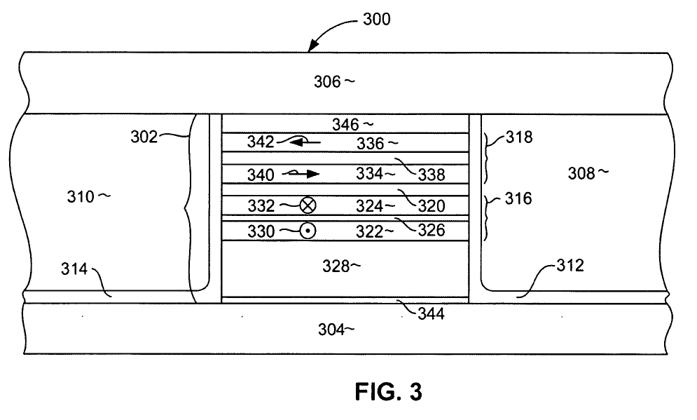

With reference now to FIG. 3, a current perpendicular to plane giant magnetoresistive (CPP GMR) sensor 300 according to an embodiment of the invention includes a sensor stack 302 that is sandwiched between first and second electrically conductive leads 304, 306, which supply a sense current to the sensor during operation. The leads 304, 306 can be constructed of a magnetic material such as NiFe so that they can function as magnetic shield layers as well as electrical leads. First and second hard bias layers 308, 310 extend laterally from the sides of the sensor stack 302. The hard bias layers 308, 310 are constructed of a hard magnetic material such as CoPtCr, etc. and provide a bias field for biasing the magnetization of the free layer, as will be described in greater detail below. First and second side insulation layers 312, 314 are formed at either lateral side of the sensor stack and across the surface of the first lead 304 to prevent sense current from being shunted through the hard bias layers 308, 310.

With continued reference to FIG. 3, the sensor stack 302 includes an antiparallel coupled (AP coupled) pinned layer structure 316 and an AP coupled free layer structure 318. A non-magnetic, electrically conductive spacer layer 320 is sandwiched between the free layer structure 318 and pinned layer structure 316. The spacer layer 320 can be constructed of a material such as Cu, Au, Ag, or a heterogeneous material. In addition, a resistive tunneling barrier material such as oxides of Al, Ti, Mg can be used.

The pinned layer structure 316 includes first and second magnetic layers 322, 324 that are antiparallel coupled across a thin, non-magnetic antiparallel coupling layer 326 such as Ru. The first magnetic layer (AP1) is exchange coupled with a layer of antiferromagnetic material (AFM layer) 328. Exchange coupling between the AFM layer 328 and the AP1 layer 322 strongly pins the magnetization of the API layer in a first direction perpendicular to the air bearing surface (ABS) as indicated by arrow head symbol 330. The antiparallel coupling between the AP1 layer 322 and AP2 layer 324 strongly pins the magnetization of the AP2 layer in a direction antiparallel to the magnetization 330 of the AP1 layer as indicated by arrow tail symbol 332.

The free layer structure 318 includes first and second magnetic layers FL1 334 and FL2 336. A thin, non-magnetic antiparallel coupling layer 338 such as Ru is sandwiched between the FL1 layer 334 and FL2 layer 336. A magnetic bias field from the hard bias layers 308, 310 biases the magnetizations of the FL1 and FL2 layers 334, 336 in opposite directions parallel with the ABS as indicated by arrow symbols 340, 342.

The sensor stack 302 can also include a seed layer 344 at the bottom of the sensor stack to initiate a desired crystalline structure in the above sensor layers. A capping layer 346 can be provided at the top of the sensor stack 302 to protect the layers of the sensor stack 302 during manufacture, especially during a high temperature anneal used to set the magnetization of the pinned layer structure 316.

One way to increase the GMR of a spin valve sensor is to use high spin polarization materials in the free and pinned layers. One candidate for this is Co2MnGe, which can have high spin polarization. In order to maximize the signal-to-noise ratio it is important to keep noise as low as possible. One major source of noise in current perpendicular to plane spin valve sensors is spin torque driven oscillations of the magnetic layers of the free and pinned layers, also referred to as spin torque noise. The current from which spin torque noise occurs (the onset current) is lower when magnetic layers with high spin polarization are used in the AP1 or the FL1 layers.

Spin torque noise can be generated in either the free layer or pinned layer of a spin valve sensor. The free layer is the weak link when a simple free-layer design is used. It undergoes spin torque driven oscillations at lower current densities than the pinned layer. The AP coupled free layer 318 described above, however, significantly reduces spin torque noise. In this case, the pinned layers undergo spin torque driven oscillations at a lower current than the free layer, limiting the total signal that can be obtained. The present invention, however, provides a pinned layer structure that significantly reduces the spin torque noise contribution from the pinned layer 316.

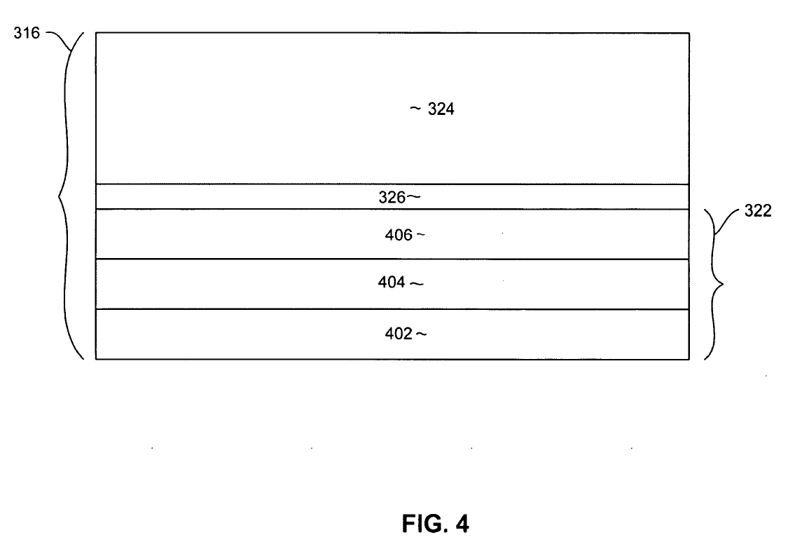

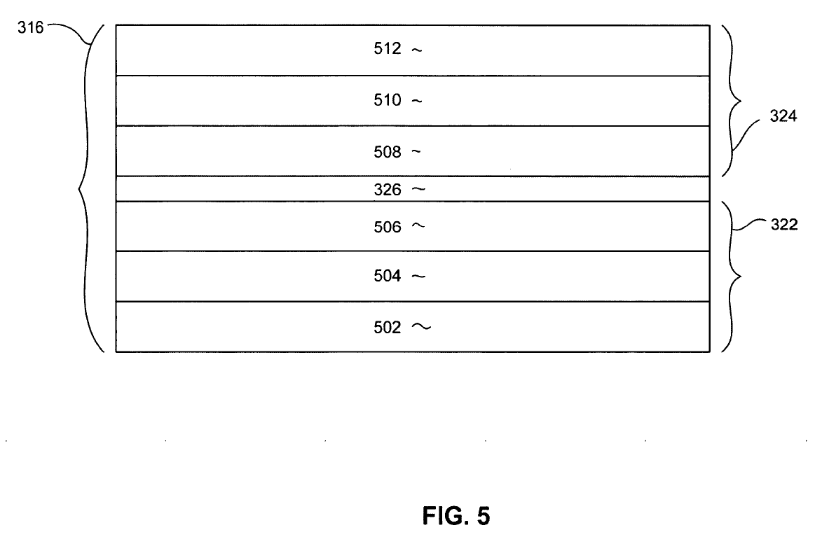

To this end, the pinned layer structure 316 has a novel construction that reduces spin torque noise. A high spin polarization material such as Co2MnGe is used in the AP1 layer 322. This can be either with a standard metal AP2 324 layer as in FIG. 4 or with a high spin polarizion AP2 324 layer as in FIG. 5. In both embodiments, the pinned layer structure reduces spin torque noise and increases the signal to noise ratio.

With reference then to FIG. 4, the structure of the pinned layer can be seen in greater detail. The AP2 layer 324 is constructed of CoFe, with preferably about 30-70 atomic percent Fe. The AP2 layer can be about 15-75 Angstroms thick, or more preferably about 39 Angstroms thick. The Ru AP coupling layer 326 can be about 8 Angstroms thick. Alternatively, a thin Ru layer of about 4A can be used. The AP1 layer 322 is a tri-layer structure including first second and third layers 402, 404, 406, the second layer 404 being located between the first layer 402 and the third layer 406. The third layer 406, located adjacent to the AP coupling layer 326, is constructed of CoFe, preferably having about 40-60 atomic percent Fe (or about 50 atomic percent Fe) and can have a thickness of 0-6 Angstroms or more preferably about 3 Angstroms. The second layer 404 is constructed of a high spin polarization material such as Co₂MnGe, and can have a thickness of 25-65 Angstroms or about 40 Angstroms. The first layer 406 is furthest from the AP coupling layer 326, and in contact with the AFM layer 328 (FIG. 3) and is constructed of CoFe with 25-55 atomic percent Fe. With an IrMn AFM layer 328, it is advantageous to use about 35 atomic percent Fe for best coupling with the antiferromagnet. The first layer 326 can have a thickness of 5-15 Angstroms or about 9 Angstroms.

With reference to FIG. 5, another embodiment of the pinned layer structure 316 is shown. In this embodiment, both the AP1 layer 322 and AP2 layer 324 have high spin polarization materials and in this embodiment are constructed as tri-layer structures. The API layer include first, second and third layers 502, 504, 506, with the third layer 506 being closest to the AP coupling layer 326 and the second layer 504 being sandwiched between the first and third layers.

The first layer 502 and the third layer 506 are both constructed of CoFe and can have 25-65 atomic percent Fe. For layer 502, about 35% is advantageous with IrMn for optimal exchange bias. The first and third layers 502, 506 can each have a thickness of 5-15 Angstroms or about 9 Angstroms. The second layer 504 is constructed of Co₂FeGe having a thickness of 25-65 Angstroms or about 40 Angstroms.

The AP2 layer 324 can have a structure similar to that of the AP1 layer 322. The AP2 layer 324 has fourth, fifth and sixth layers 508, 510, 512, with the fifth layer 508 being closest to the AP coupling layer 326 and the fifth layer 510 being between the fourth and sixth layers 508, 512. The fourth layer 508 and the sixth layer 512 are both constructed of CoFe and can have 35-65 atomic percent Fe or about 50 atomic percent Fe. The fourth layer 508 can have a thickness of 5-15 Angstroms or about 9 Angstroms. The sixth layer 512 can have a thickness of up to 10 Angstroms or about 5 Angstroms. The fifth layer 510 is constructed of Co₂FeGe having a thickness of 25-65 Angstroms or about 40 Angstroms.

Using a high spin polarization material such as Co₂MnGe in the AP2 layer 324 increases GMR. For example, a spin valve having a CoFe AP2 layer can achieve GMR of 4.4%, whereas a spin valve having Co₂MnGe in the AP2 layer can achieve GMR of 8.1 %. In this example, a non-stochiometric Co2MnGe layer was used, where the Ge content was 28 atomic percent. Adding Co₂MnGe to the API layer as well as the AP2 layer decreases the GMR slightly from 8.1% to 6.9%. Although this teaches away from the use of Co2MnGe in both the AP1 and AP2 layers, the use of this material in both the AP1 and AP2 layers 322, 324 has been found to increase the resistance-area product, RA, value significantly with the use of Co₂MnGe in both layers 322, 324. The actual signal one obtains is proportional to the change in the resistance-area product, RA, of a CPP-GMR stack. This parameter, delta-RA, is the same for a structure having Co₂MnGe in both layers 322, 324 as it is for a structure with Co₂MnGe in the AP2 332 layer only, even though ΔR/JR is lower. However, as mentioned above, the onset current for spin torque noise is significantly higher when Co₂MnGe is used in both layers 322, 324. Therefore, there is a large increase in the signal to noise ratio.

The performance of the sensor the 300, is however affected by the direction of electron flow through the sensor. Performance is greatly improved if the sense current flows such that electrons travel from top to bottom as shown in FIG. 3. That is, for maximum performance it is desirable that the sense current be provided such that electrons flow first through the free layer structure 318, and then through the pinned layer structure 316.

As can be seen, then, the above embodiments disclose a sensor 300 having greatly improved sensor performance. While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetoresistive sensor, comprising:
a magnetic free layer structure;
an antiparallel coupled magnetic pinned layer structure including a first magnetic layer (AP1) and a second magnetic layer (AP2) where the AP1 includes a high spin polarization material; and
a non-magnetic spacer layer sandwiched between the magnetic free layer structure and the magnetic pinned layer structure.

2. a magnetoresistive sensor as in claim 1 wherein the high spin polarization material comprises Co2MnX or CoFeX where X is one or more of Ge, Si, Al, Ga, and Sn.

3. A magnetoresistive sensor as in 2 where the high spin polarization material is sandwiched between layers of first and second layers of CoFe.

4. A magnetoresistive sensor as in claim 2 wherein the layer comprising Co2MnX has between 25 and 33 atomic percent X.

5. A magnetoresistive sensor as in claim 2 wherein the layer comprising CoFeX has between 28 and 35 atomic percent X.

6. A magnetoresistive sensor as in claim 3 wherein the first and second layers of CoFe each have 25-65 atomic percent Fe.

7. A magnetoresistive sensor as in claim 3 wherein the first and second layers of CoFe each have about 50 atomic percent Fe.

8. A magnetoresistive sensor as in claim 3 wherein the first and second layers of CoFe each have a thickness of 5-15 Angstroms.

9. A magnetoresistive sensor as in claim 3 wherein the first and second layers of CoFe each have a thickness of about 9 Angstroms.

10. A magnetoresistive sensor as in claim 2 wherein the layer comprising CoMnX or CoFeX has a thickness of 25-65 Angstroms.

11. A magnetoresistive sensor as in claim 2 wherein the layer comprising Co2MnX or CoFeX has a thickness of about 40 Angstroms.

12. A magnotoresistive sensor as in claim 1 wherein the free layer structure further comprises third and fourth magnetic layers (FL1 and FL2) and a second thin non-magnetic antiparallel coupling layer sandwiched therebetween.

13. A magnetoresitive sensor as in claim 12 wherein the FL1 layer is disposed adjacent to the non-magnetic spacer layer and further comprises a layer of Co2MnX sandwiched between third and fourth layers of CoFe.

14. A magnetoresitive sensor as in claim 12 wherein the FL1 layer is disposed adjacent to the non-magnetic spacer layer and further comprises a layer of CoFeX sandwiched between third and fourth layers of CoFe.

15. A magnetoresitive sensor as in claim 12 wherein the FL1 layer is disposed adjacent to the non-magnetic spacer layer and further comprises a layer of Co₂MnX sandwiched between third and fourth layers of CoFe.

16. A magnetoresistive sensor as in claim 10 wherein the layer comprising Co2MnX has between 25 and 33 atomic percent X.

17. A magnetoresistive sensor as in claim 14 wherein the layer comprising CoFeX has between 28 and 35 atomic percent X.

18. A magnetoresistive sensor, comprising:
a magnetic free layer structure;
an antiparallel coupled magnetic pinned layer structure including a first magnetic layer (AP1) and a second magnetic layer (AP2), where both the AP1 and AP2 layers comprise a layer of high spin polarization material
a non-magnetic spacer layer sandwiched between the magnetic free layer structure and the magnetic pinned layer structure.

19. A magnetoresistive sensor as in claim 18 wherein the high spin polarization material comprises Co2MnX or CoFeX where X is one or more of Ge, Si, Al, Ga, and Sn.

20. A magnetoresistive sensor as in 18 where the high spin polarization material is sandwiched between layers of first and second layers of CoFe.

21. A magnetoresistive sensor as in claim 18 wherein the second magnetic layer (AP2) is located adjacent to the non-magnetic spacer layer.

22. A magnetoresistive sensor as in claim 20 wherein the first and second layers of CoFe have 25-65 atomic percent Fe.

23. A magnetoresistive sensor as in claim 20 wherein the first and second layers of CoFe have about 50 atomic percent Fe.

24. A magnetoresistive sensor as in claim 20 wherein the first and second layers of CoFe each have a thickness of 0-5 Angstroms.

25. A magnetoresistive sensor as in claim 20 wherein the first and second layers of CoFe each have a thickness of 0-5 Angstroms and the layer of Co2MnX has a thickness of 25-75 Angstroms.

26. A magnetoresistive sensor as in claim 20 wherein the first and second layers of CoFe each have a thickness of 0-5 Angstroms and the layer of CoFeX has a thickness of 25-75 Angstroms.

27. A magnetoresistive sensor as in claim 18 wherein the second magnetic layer (AP2) has 30-70 atomic percent Fe.

28. A magnetoresistive sensor as in claim 18 wherein the free layer further comprises third and fourth magnetic layers and a second non-magnetic antiparallel coupling layer sandwiched therebetween.

29. A magnetoresistive sensor as in claim 18 wherein the free layer further comprises third and forth magnetic layers and a second non-magnetic antiparallel coupling layer sandwiched therebetween, the third magnetic layer comprising a layer of Co2MnX sandwiched between third and fourth layers of CoFe.

30. A magnetoresistive sensor as in claim 18 wherein the free layer further comprises third and forth magnetic layers and a second non-magnetic antiparallel coupling layer sandwiched therebetween, the third magnetic layer comprising a layer of CoFeX sandwiched between third and fourth layers of CoFe.

31. A magnetoresistive sensor as in claim 29 wherein the third magnetic layer is located adjacent to the non-magnetic spacer layer.
